(19) United States
(12) Patent Application Publication
(10) Pub. No.: US 2014/0027596 A1
(43) Pub. Date: Jan. 30, 2014

(54) EXTENSION ROD WORKING WITH FIXER FOR HANDHELD, PORTABLE, MOBILE DEVICES

(71) Applicant: Michael Chau-Lun CHANG, Taipei City (TW)

(72) Inventor: Michael Chau-Lun CHANG, Taipei City (TW)

(21) Appl. No.: 13/657,878

(22) Filed: Oct. 23, 2012

(30) Foreign Application Priority Data
Jul. 30, 2012 (TW) 101214669
Sep. 26, 2012 (CN) 201220495615.2

(51) Int. Cl. F16M 13/02

(52) U.S. Cl. 248/333

(57) ABSTRACT

An extension rod working with a fixer for handheld, portable, mobile devices includes a rod body whose two ends are detachably attached with a positioning frame and a securing member that are both of an external fixer, respectively. The positioning frame holds an external mobile device, and the securing member secures the rod body and the positioning frame onto an external article, so as to suspend the mobile device. The rod body its one end coupled with a second linking portion of the positioning frame and has the other end provided with a first linking portion that is configured to engage with the securing member. The extension rod can be easily and quickly mounted on or dismounted from any nearby handrail. When the positioning frame and the securing member are detached from the two ends of the rod body, the rod body can function as an umbrella or the like.

### BACKGROUND OF THE INVENTION

1. Technical Field

The present invention relates to an extension rod working with a fixer for handheld, portable, mobile devices. The fixer is portable and serves to suspend a mobile electronic device, such as a mobile phone, a portable game player, an electronic book, a GPS device or a tablet computer, and the extension rod is designed to work with such a fixer.

2. Description of Related Art

Recently, handheld, mobile devices such as mobile phones and tablet computers have been popular, and nowadays almost everyone has one. While these mobile devices are relatively compact and light-weight, holding them in hand for a sustained time period is still a significant, accumulative burden to muscle, and this is particularly true for people lacking exercise.

There are some fixers designed for small-size mobile devices, but these fixers commonly fail to provide the advantages desired by users, such as being easy to mount and dismount, being compact and light, and being retractable, thereby being more portable.

The existing fixing tools for mobile devices are mainly using a flexible hose ended with a clamp that is configured to hold the whole tool on a table plate. While such an existing fixing tool is effective in suspending a mobile device over a table, it is structurally weak and tends to deform and come down after a long term of suspension. Also due to its weakness, for operating the mobile device, a user has to first use one hand support the mobile device from its back and then use the other hand to touch the touch screen. This causes the existing fixing tools to be unfavorable to mobile device operation.

Moreover, in the existing fixing tool, the clamp can only work well with a planar support. However, when leaving a house and used in a public transportation vehicle, such as a MRT train, a subway or a bus, where there are only vertical mop stick handrails, the fixing tool fails because its clamp cannot engage with the handrails effectively. The above-mentioned problems are for us to solve.

### BRIEF SUMMARY OF THE INVENTION

The present invention provides an extension rod working with a fixer that is portable and serves to hold and suspend a mobile electronic device, such as a mobile phone, a portable game player, an electronic book, a GPS device or a tablet computer. The primary objective of the present invention is to suspend a mobile device with proper overall rigidity, so that a user can operate the suspended mobile device by touching or sliding on its touch screen without displacing the mobile device from where it is positioned. Also, the disclosed fixer is configured to firmly grasp a smooth, vertical rod, so that a user riding a public transportation vehicle can conveniently suspend and use his/her mobile device in the vehicle, wherein the fixer supports the mobile device with proper overall rigidity, so that a user can operate the suspended mobile device by touching or sliding on its touch screen. Thereby, the present invention is helpful to prevent users' muscle fatigue and ache caused by overuse of neck and shoulder muscles.

To achieve the foregoing objective, the present invention provides an extension rod working with a fixer for handheld, portable, mobile devices, which comprises: a rod body whose two ends are detachably attached with a positioning frame and a securing member that are both of an external fixer, respectively, the positioning frame serving to holding and positioning an external mobile device, the securing member serving to attach and secure the rod body and the positioning frame onto an external article, so as to suspend the mobile device, wherein the external article is a planar or a bar-like article, the extension rod being characterized in:

the rod body having one said end coupled with a second linking portion of the positioning frame and having the other said end providing with a first linking portion that is configured to engage with the securing member, the rod body being rigid in either a vertical direction or a horizontal direction, the securing member being configured to grasp a horizontal or vertical, planar or bar-like article, so that when a user touches and operates the mobile device, the mobile device is strongly positioned over the external article by the extension rod and the locking unit, and is prevented from swinging and displacing.

### BRIEF DESCRIPTION OF THE SEVERAL VIEWS OF THE DRAWINGS

FIG. 1 is a front view of one preferred embodiment of the present invention;

FIG. 2 is a top view of FIG. 1;

FIG. 3 is a perspective view of the positioning frame as shown in FIG. 1;

FIG. 4 is a front view of an additional mode of the present invention;

FIG. 5 is a front view of another additional mode of the present invention;

FIG. 6 is a top view of FIG. 5;

FIG. 7 is a partially enlarged applied view of FIG. 5;

FIG. 8 is a front view of another additional mode of the present invention;

FIG. 9 is an applied view of the present invention;

FIG. 10 is another applied view of the present invention; and

FIG. 11 is a cross-sectional view of the rod body as shown in FIG. 8.

### DETAILED DESCRIPTION OF THE INVENTION

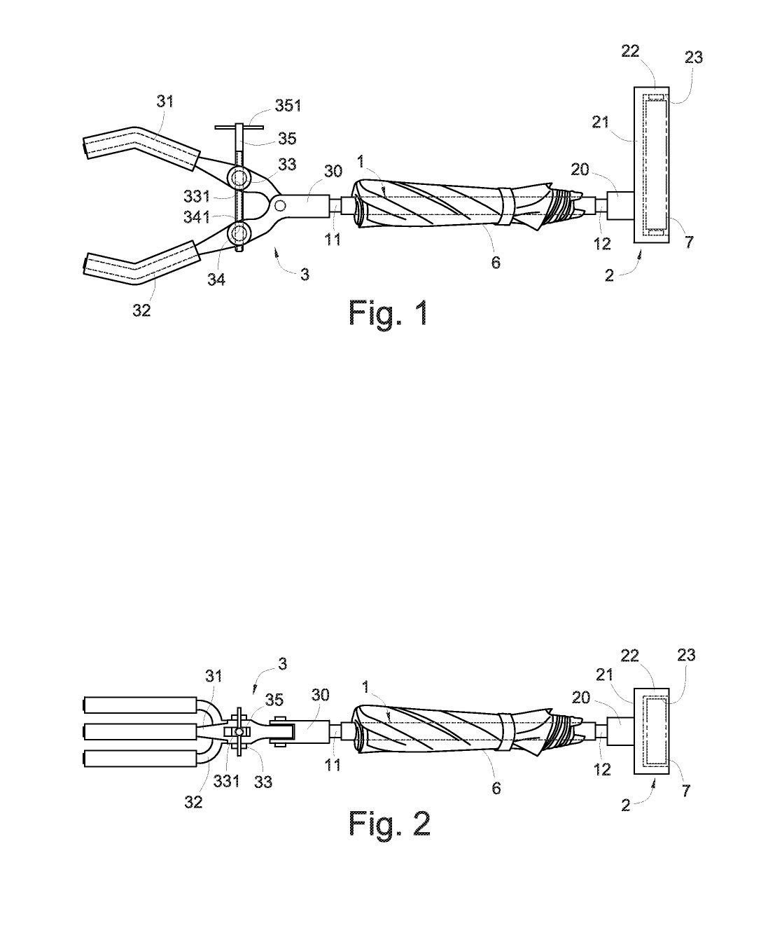

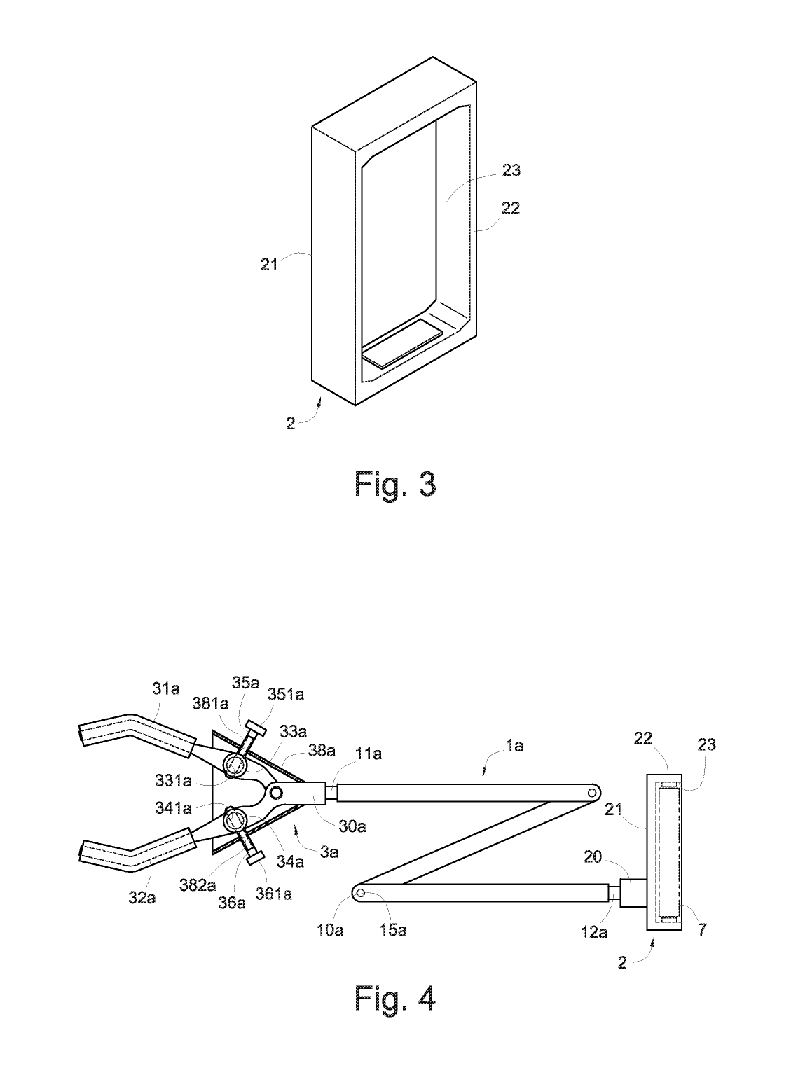

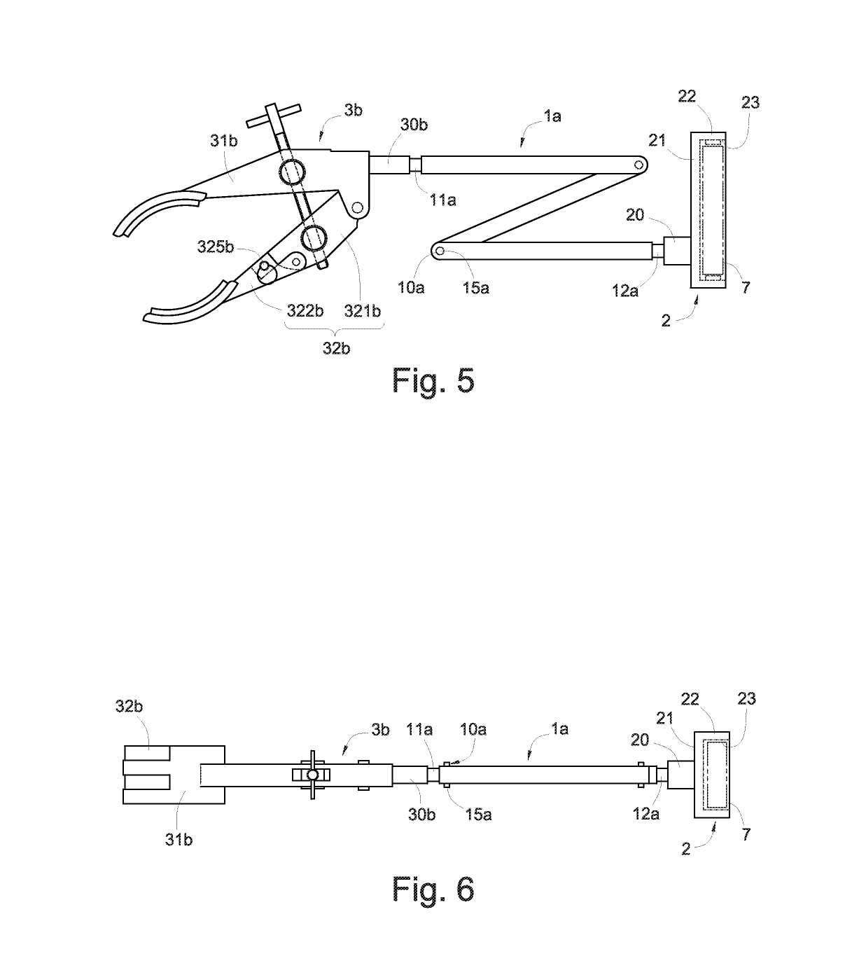

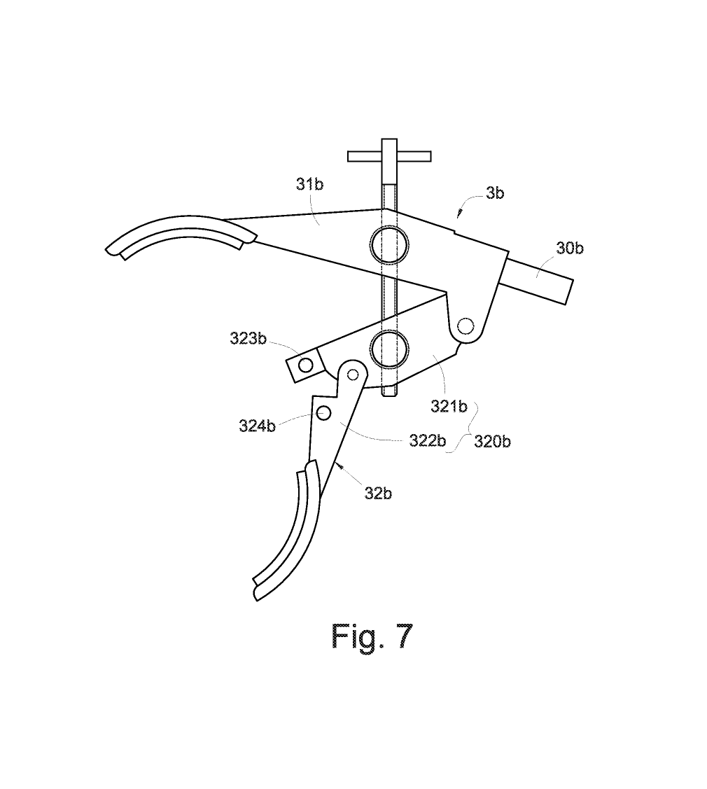

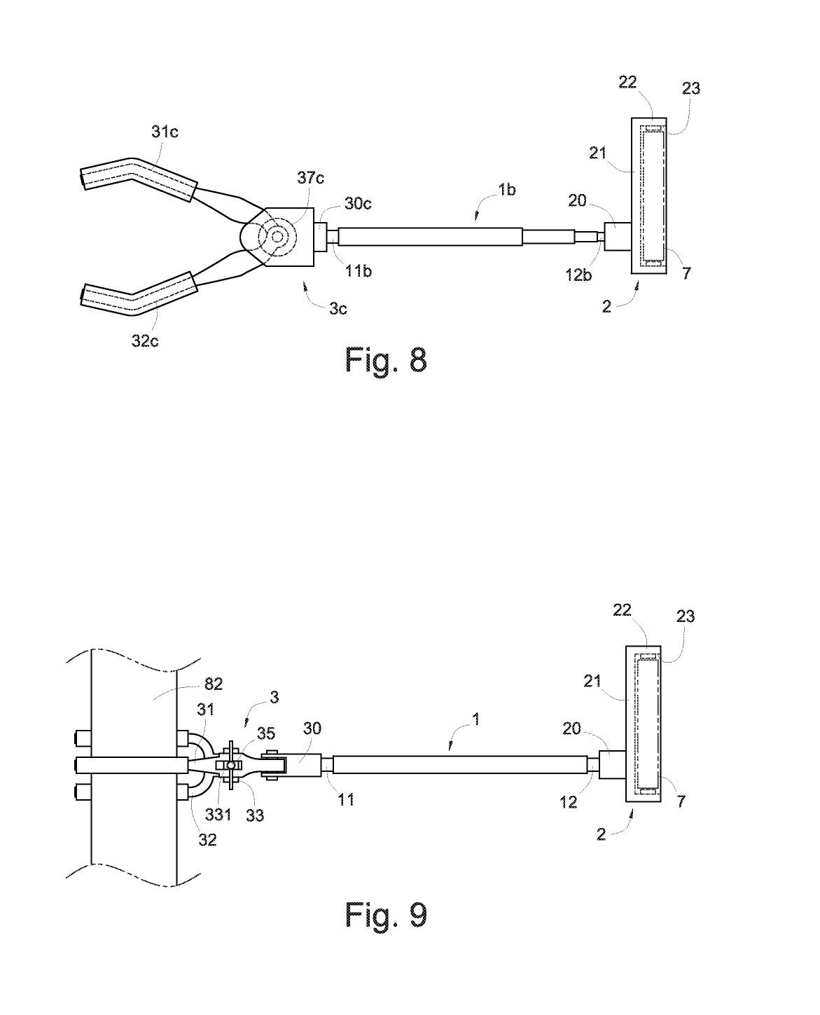

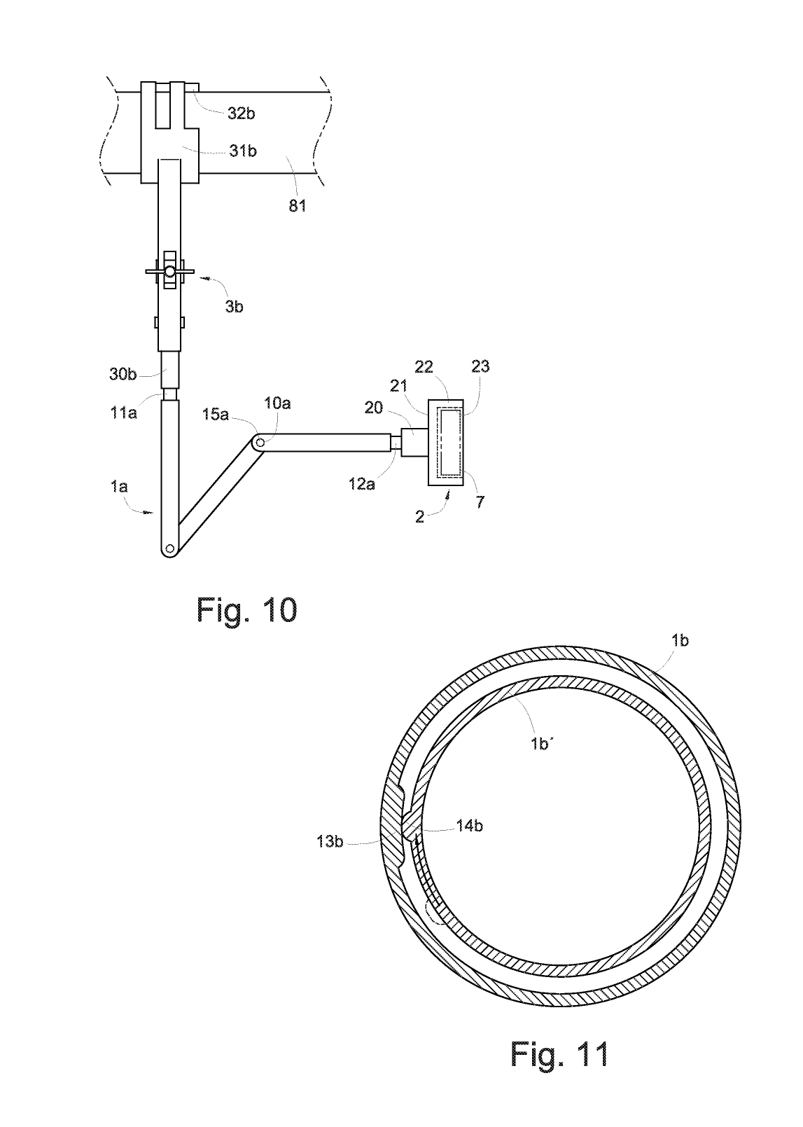

FIG. 1 through FIG. 11 depict preferred embodiments of the present invention. As shown, the disclosed extension rod working with a fixer for handheld, portable, mobile devices comprises a rod body 1, which has a round or polygonal cross-sectional shape. The rod body 1 has two ends detachably provided with a positioning frame 2 and a securing member 3 with the external fixer, respectively. The positioning frame 2 serves to hold and position an external mobile electronic device 7, such as a mobile phone, a portable game player, an electronic book, a GPS device or a tablet computer. The securing member 3 serves to secure the rod body 1 and the positioning frame 2 to an external article, so as to suspend the mobile device 7 over the external article, which may be a planar or a bar-like object.

The rod body 1 has one of its ends provided with a second linking portion 12 for engaging with the positioning frame 2. The other end of the rod body 1 has a first linking portion 11 for engaging with the securing member 3. The rod body 1 is rigid in either a vertical direction or a horizontal direction.

The securing member 3 is configured to rapidly and firmly grasp the external article no matter it is a horizontal or vertical planar structure, a cylinder or a lengthwise rod, pole or bar-like support, so as to support the mobile device 7 for a user to operate. When operated by the user, the mobile device 7 is strongly positioned over the external article by the rod body 1, and is prevented from swinging and displacing.

The rod body 1 may be a horizontal handrail 81 or a vertical handrail 82 provided in a public transportation vehicle for passengers to hold.

The rod body 1 may be an integral or telescopic pole-like portable personal article, which may be an umbrella, a crutch, a walking stick, a cane, a fishing pole, a pen, a microphone stand or a music stand, so that when the positioning frame 2 and the securing member 3 are detached from the two ends of the rod body 1, respectively, the rod body 1 serves to be used as the umbrella, the crutch, the walking stick, the cane, the fishing pole, the pen, the microphone stand or the music stand. In this case, the rod body 1, when acting as an umbrella, a crutch, a walking stick, a cane, a fishing pole, a pen, a microphone stand or a music stand, may have each of the first linking portion 11 and the second linking portion 12 at its two ends provided with a cap or a sheath for protecting the first linking portion 11 and the second linking portion 12. In the case where the rod body 1 can be used as an umbrella (or a parasol), the rod body 1 supports an umbrella frame that is covered by a piece of umbrella cloth 6.

The securing member 3 has at least one movable clamping jaw 31 or 32.

As shown, the securing member 3 has at least two symmetrical movable clamping jaws 31 and 32. Each of the clamping jaws 31 and 32, is provided with a pivot 33 or 34. The pivot 33 or 34 is formed with a threaded hole 331 or 341. The threaded holes 331 and 341 on the pivot 33 and 34 of the clamping jaw 31 or 32 are configured to receive a threaded bolt 35. The threaded bolt 35 serves to adjust an included angle between the clamping jaws 31 and 32 unilaterally, so as to hold or release the external article. The threaded bolt 35 has one end provide with an adjusting lever 351 for a user to operate and thereby drive the threaded bolt 35 to rotate.

Alternatively, the securing member 3a has at least two symmetrical movable clamping jaws 31a and 32a and a sheath 38a housing the clamping jaws 31a and 32a at their roots. Each of the clamping jaws 31a and 32a is provided with a pivot 33a or 34a. Each of the pivots 33a and 34a is formed with a threaded hole 331a or 341a. The sheath 38a is formed with two threaded holes 381a and 382a aligned with the pivots 33a and 34a, respectively. Each of the threaded holes 331a and 341a on the pivots 33a and 34a of the clamping jaws 31a and, 32a is pierced together with the corresponding threaded hole 381a or 382a on the sheath 38a by a threaded bolt 35a or 36a. The threaded bolts 35a and 36a serve to adjust an included angle between the clamping jaws 31a and 32a bilaterally, so as to hold or release the external article. Each of the threaded bolts 35a and 36a has one end provided with an adjusting lever 351a or 361a for a user to operate and thereby drive the threaded bolt 35a or 36a to rotate.

Alternatively, the securing member 3c has at least two symmetrical movable clamping jaws 31c and 32c and the a driver 37c is provided on the securing member 3c for driving the clamping jaws 31c and 32c and thereby adjusting an included angle between the clamping jaws 31c and 32c. The driver 37c may be a motor.

The securing member 3, 3a, 3b or 3c is tailed by a first connecting portion 30, 30a, 30b or 30c for connecting the first linking portion 11, 11a or 11b of the rod body 1, 1a or 1b. The first connecting portion 30, 30a, 30b or 30c and the first linking portion 11, 11a or 11b are combined by insertion, buckle engagement, embedding, embracing, rotational connection, pivotal connection, suction, magnetism, screwing connection, Velcro tapes, adhesive or being formed integratedly.

The clamping jaw 31b or 32b has a releasing device 320b. The releasing device 320b includes a root 321b pivotally connected to the securing member 3b, and a tip 322b that is pivotally connected to the root 321b and is far from the securing member 3b. The root 321b and the tip 322b have their connecting surfaces each provided with a positioning hole 323b or 324b. A positioning rod 325b passes through the positioning holes 323b, 324b so as to fix the tip 322b with respect to the root 321b. When there is an urgent need to detach the securing member 3b from the horizontal handrail 81 or the vertical handrail 82 in the public transportation vehicle, the positioning rod 325b of the releasing device 320b can be pulled out to allow the tip 322b to swing outward, so that the securing member 3b can be invalidated by pulling open the releasing device 320b.

The rod body 1, 1a or 1b may be a unitary member or a composite member. In the later case, the rod body 1b or 1b′ is formed by telescoped tubes 1b and 1b′, so that the rod body is allowed to have multi-stage extension, thereby increasing an overall using length of the extension rod. Each two adjacent tubes 1b and 1b′ telescoped have contacting surfaces thereof provided with a first retainer 13b and a second retainer 14b, respectively. The first retainer 13b may be a raised portion formed on the inner wall of the rod body 1b, and the second retainer 14b may be another raised portion formed on the outer wall of the rod body 1b′, so that the rod body is adjustable in length.

Alternatively, the extension rod 1a is formed by links pivotally linked by one or more movable joints 10a, so that the rod body 1a is foldable and is allowed to have multi-stage extension, thereby increasing an overall using length of the extension rod. Each said joint 10a has an adjusting screw 15a for fixing the links in position or releasing the links for angular adjustment from 0 to 360 degrees. The movable joint 10a may be a pivot or a universal connector.

The extension rod 1, 1a or 1b is normally retracted in a compact size for portability, and can be extended in length or adjusted in angle to an extent where a user can conveniently view and operate the screen of the mobile device 7.

The positioning frame 2 has a second connecting portion 20 at its back, and the end of the extension rod 1, 1a or 1b has a second linking portion 12, 12a or 12b for engaging with the second connecting portion 20 of the positioning frame 2. The second connecting portion 20 and the second linking portion 12, 12a or 12b are combined by insertion, buckle engagement, embedding, embracing, rotational connection, pivotal connection, suction, magnetism, screwing connection, Velcro tapes, adhesive or being formed integratedly.

The positioning frame 2 may be an extendable jacket. The jacket has a base 21 and an elastic enclosure 22 circling the base 21. A positioning recess 23 is defined between the base 21 and the inner wall of the enclosure 22, for fittingly receiving the mobile device 7. In addition, the base 21 has a second connecting portion 20 at its back, for engaging with the second linking portion 12 of the rod body 1. The positioning frame 2 can pivot on the second connecting portion 20 to rotate with respect to the extension rod 1, 1a or 1b up to 90 degrees.

Thereby, the extension rod of the fixer is highly portable and can be quickly and conveniently attached to a horizontal handrail 81 or a vertical handrail 82 in a public transportation vehicle by means of the securing member 3, 3a, 3b or 3c. In virtue of the positioning frame 2, the whole assembly frees the user's hand from holding the mobile device 7.

It is to be noted that the rod body 1, 1a or 1b is such designed that when the positioning frame 2 and the securing member 3, 3a, 3b, 3c are detached from the first linking portion 11, 11a, 11b and the second linking portion 12, 12a, 12b at the two ends of the rod body 1, 1a, 1b, respectively, the rod body 1, 1a or 1b can be used independently as a portable tool, sic as a crutch, a walking stick, a fishing pole, a pen, a microphone stand or a music stand. When the rod body 1 is formed with an umbrella frame that is covered by a piece of umbrella cloth 6, it can be use as an umbrella or a parasol.

Thereby, the extension rod of the fixer of convenient to carry, and can be rapidly secured to or detached from any nearby handrails 81 and 82 by means of the securing member 3, 3a, 3b, 3c. In virtue of the positioning frame 2 that holds and positions the mobile device 7, the whole assembly is helpful to prevent users' muscle fatigue and ache caused by overuse of neck and shoulder muscles. In addition, the positioning frame 2 and the securing member 3, 3a, 3b, 3c at the two ends of the rod body 1, 1a or 1b can be easily detached, so that the rod body 1, 1a or 1b to be independently used as a portable personal article, such as an umbrella, a crutch, a walking stick, a cane, a fishing pole, a pen, a microphone stand or a music stand, as designed.

What is claimed is:

1. An extension rod working with a fixer for handheld, portable, mobile devices, the extension rod comprising a rod body whose two ends are detachably attached with a positioning frame and a securing member that are both of an external fixer, respectively, the positioning frame serving to hold and position an external mobile device, the securing member serving to attach and secure the rod body and the positioning frame onto an external article, so as to suspend the mobile device, wherein the external article is a planar or a bar-like article, the extension rod being characterized in:
the rod body having one said end coupled with a second linking portion of the positioning frame and having the other said end provided with a first linking portion that is configured to engage with the securing member, the rod body being rigid in either a vertical direction or a horizontal direction, the securing member being configured to grasp a horizontal or vertical, planar or bar-like article, so that when a user touches and operates the mobile device, the mobile device is strongly positioned over the external article by the extension rod and the locking unit, and is prevented from swinging and displacing.

2. The extension rod of claim 1, wherein the rod body is an integral or telescopic pole-like portable personal article, which is an umbrella, a crutch, a walking stick, a cane, a fishing pole, a pen, a microphone stand or a music stand, so that when the positioning frame and the securing member are detached from the two ends of the rod body, respectively, the rod body serves to be used independently as the umbrella, the crutch, the walking stick, the cane, the fishing pole, the pen, the microphone stand or the music stand.

3. The extension rod of claim 1, wherein the positioning frame has a second connecting portion for engaging with the second linking portion of the rod body.

4. The extension rod of claim 1, wherein the securing member has a first connecting portion for engaging with the first linking portion of the rod body.

5. The extension rod of claim 1, wherein the rod body is formed by telescoped tubes, so that the rod body is allowed to have multi-stage extension, thereby increasing an overall using length of the rod body, in which each two adjacent tubes telescoped have contacting surfaces thereof provided with a first retainer and a second retainer, respectively, the first and second retainers being configured to removably engage with each other so that the rod body is adjustable in length.

6. The extension rod of claim 1, wherein the rod body is formed by links, in which each two adjacent two said links that are pivotally linked by a movable joint, so that the rod body is foldable and is allowed to have multi-stage extension, thereby increasing an overall using length of the rod body, and each said joint has an adjusting screw for fixing the links in position or releasing the links for angular adjustment therebetween.
